(19) United States
(12) Patent Application Publication
(10) Pub. No.: US 2021/0035243 A1
(43) Pub. Date: Feb. 4, 2021

(54) Payment System

(71) Applicants: Aftab Farooqi, Redmond, WA (US); Moin Moinuddin, Remond, WA (US)

(72) Inventors: Aftab Farooqi, Redmond, WA (US); Moin Moinuddin, Remond, WA (US)

(21) Appl. No.: 16/526,237

(22) Filed: Jul. 30, 2019

(51) Int. Cl. G06Q 50/12; G06Q 30/06; G06Q 20/20; G06Q 30/02; G06Q 10/08; A47F 10/06

(52) U.S. Cl. CPC G06Q 50/12; G06Q 30/0601; A47F 10/06; G06Q 30/02; G06Q 10/087; G06Q 20/20

(57) ABSTRACT

A payment system may include ways for an entity, such as a restaurant, to provide ordering and payment services, among other services, to customers, who may use their own devices. For example, customers may use their own devices to order and pay for food or drinks that they pick up or consume at a restaurant.

### FIELD

This disclosure relates to a payment system.

### BACKGROUND

Over the last decade, consumers have adopted smartphones and mobile devices for making daily activities more convenient. One such activity entails using smartphones or mobile devices for making payments. Payments made using smartphones or mobile devices may be referred to as mobile payments.

Payment solutions using smartphones or mobile devices may be integrated into restaurant business models. The ease of adopting and using any payment solution is one factor for deciding on the type of technology to integrate. Accordingly, various payment solutions have been implemented in restaurants. For example, some restaurants may provide hardware that enables customers to pay at dining tables. However, such devices may increase restaurant overhead costs, take up too much table space, or may have a steep learning curve for consumers, among other downsides.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a payment system, which may include a system or way for any entity, such as a restaurant, to provide payment services to customers. For example, in one embodiment, customers may use their own hardware, which runs a payment system on it, to execute transactions. Accordingly, using an application on the customer's smartphone or mobile device, payment and order data, among other data, may be received by an entity, such as a restaurant.

A customer with a payment system on his or her device may have a payment method associated with the payment system. Once the customer has completed dining or receiving any other service, payment may be processed. Payment may be processed after an order is marked complete. In contrast to traditional business models, there may be no physical or designated point of sale.

Many of the attendant features may be more readily appreciated as they become better understood by reference to the following detailed description considered in connection with the attached drawings.

### BRIEF DESCRIPTION OF THE DRAWINGS

FIG. 1 illustrates a user interface layout for a device application using a payment system, according to one embodiment.

FIG. 2 is a top view of a restaurant using a payment system, according to one embodiment.

FIG. 3 is a flow diagram illustrating a process for a payment system, according to one embodiment.

FIG. 4 is an entity relationship diagram illustrating an example of data and relationships in a payment system.

FIG. 5 is a block diagram illustrating an example of a system capable of supporting a payment system, according to one embodiment.

FIG. 6 is a component diagram of a computing device to which a payment system may be applied, according to one embodiment.

FIG. 7 illustrates a user interface for a device application using a payment system, according to another embodiment.

### DETAILED DESCRIPTION

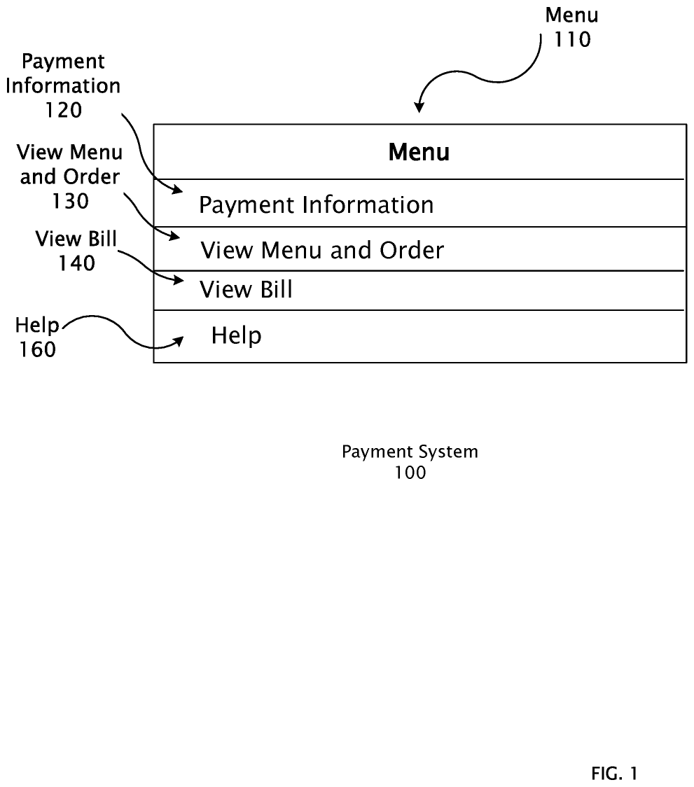

FIG. 1 illustrates a user interface layout for a device application using Payment System 100, according to one embodiment. In this example, Menu 110 may display a drop-down menu of action items which a customer may select on a device. For example, a customer may select Payment Information 120 to enter credit card, debit card, cryptocurrency, or any other information allowing a transaction to occur. In one embodiment, a digital transaction may occur between a financial institution, such as a bank, and an entity, such as a restaurant. In another embodiment, a customer may select Payment Information 120 and input promotional codes, gift cards, or any other alternative payment method. Selecting View Menu and Order 130 may allow a customer at a restaurant to place an order for any food or drinks by selecting items on a restaurant's menu. In one embodiment, a customer may place take-out orders at a restaurant. In another embodiment, a customer may place orders for dining in at the restaurant. In yet another embodiment, a customer may place an order for delivery. Selecting View Bill 140 may produce a variety of options for displaying a bill to the customer. For example, in one embodiment, the customer may view an itemized bill, updated in real time. Selecting Help 160 may enable a customer to chat with a technical consultant to troubleshoot any issues with using an application supporting Payment System, summon a manager or wait staff, or view answers to common questions about using Payment System. Menu 110 may have various components and configurations, and it may be available in any language and any commercial or non-commercial context. For example, Payment System 100 commands may allow a person to submit a song request at a restaurant or facilitate coat check.

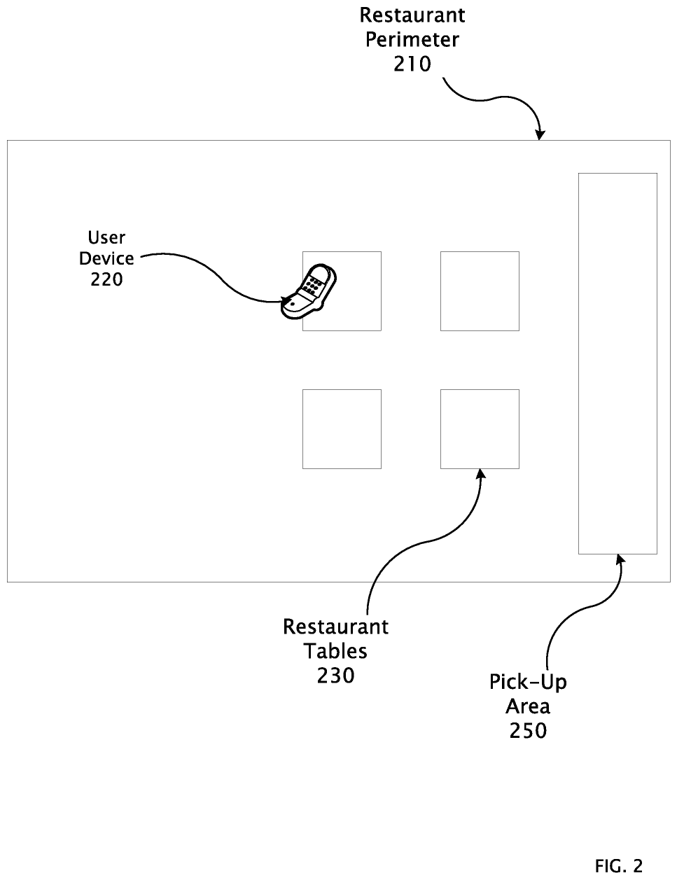

FIG. 2 is a top-view of a restaurant using Payment System 100, according to one embodiment. Restaurant Perimeter 210 may represent the external property boundaries of a restaurant. Payment System 100 may use Global Position System (GPS), a location-based Service (LBS), or other ways to determine if a location of User Device 220. User Device 220 may represent a variety of mobile or hand-held portable devices, configured to run an application supporting Payment System 100. Restaurant Tables 230 may represent a dining area from which customers may use Payment System 100 to place orders for dining at the restaurant. Pick-Up Area 250 may represent an area where customers may receive take-out orders placed using Payment System 100.

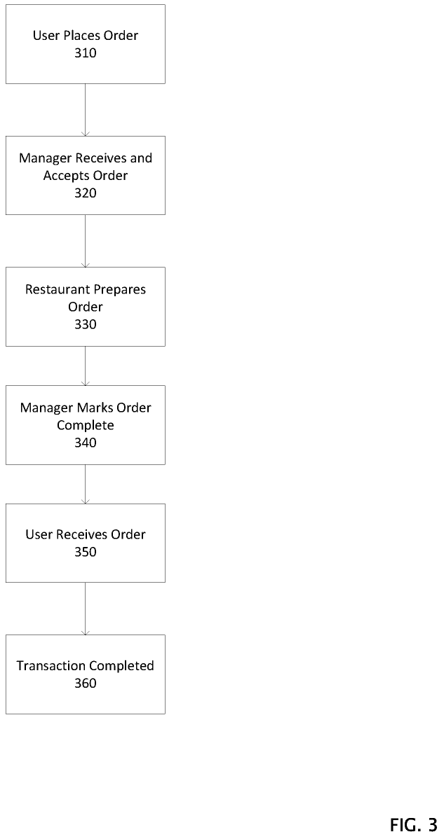

FIG. 3 is a flow diagram illustrating a process for Payment System, according to one embodiment. At User Places Order 310, a restaurant customer may use an application supporting Payment System on a mobile device or any other device to place food or beverage orders. In one embodiment, orders may be placed for dining in. In another embodiment, orders may be placed for pick up. Orders may be placed at a variety of restaurants, regardless of a customer's actual proximity to any restaurant. In one embodiment, users may enter payment information, such as credit card information, before a user places the order. Alternatively, in another embodiment, payment information may be entered after a customer places the order. At Manager Receives and Accepts Order 320, in one embodiment, a manager or anyone in a supervisory capacity using Payment System may receive food or beverage orders placed by customers using Payment System 100. Using Payment System 100, the manager or supervisor may review any orders before accepting the orders and sending them to the kitchen. At Restaurant Prepares Order 330, after a restaurant kitchen receives any orders from any manager or supervisor, a restaurant may prepare any food or beverages contained in a corresponding order. At Manager Marks Order Complete 340, after the restaurant kitchen has fulfilled any orders placed, a manager or supervisor may mark open orders as complete on Payment System 100. Following this, at User Receives Order 350, in one embodiment, a user dining in at the restaurant may be served his or her order. Alternatively, in another embodiment, a user not dining in at the restaurant may pick-up his or her order. At Transaction Completed 360, a user's payment may be processed. In one embodiment, the user may also add tips, provide feedback to the restaurant, or write reviews. A restaurant using Payment System may choose when and how to process payments. In one embodiment, payments may be processed at the end of the day. A variety of processing options may be available to restaurants.

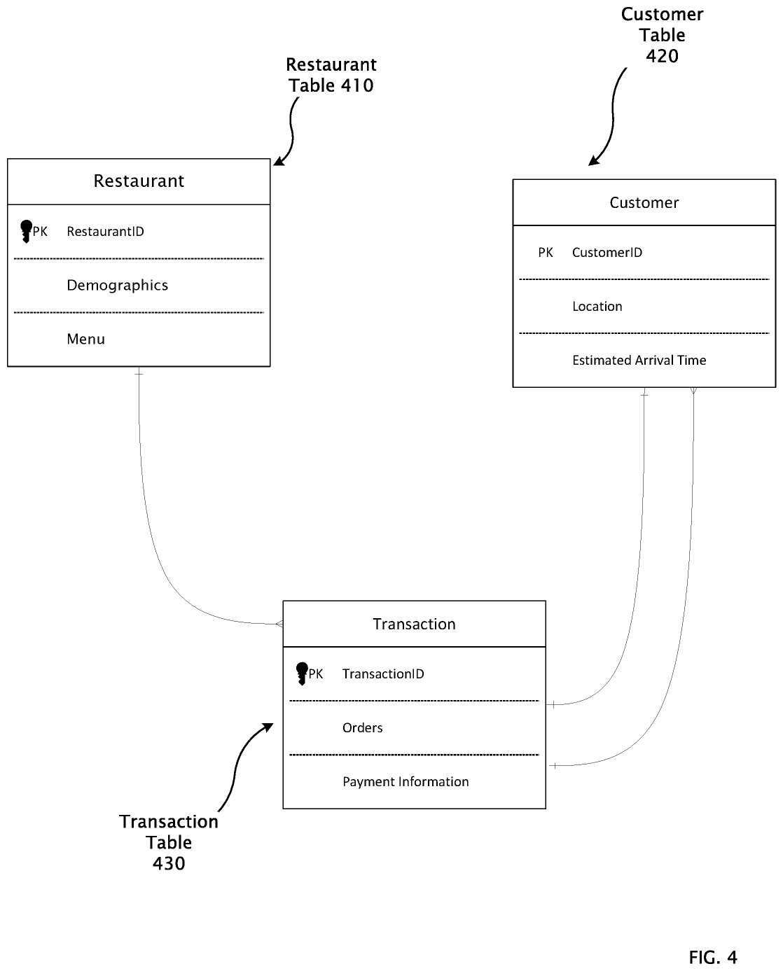

FIG. 4 is an entity relationship diagram illustrating an example of data and relationships in Payment System 100. In one embodiment, Restaurant Table 410 may contain data related to a restaurant. For example, Restaurant Table 410 may contain data related to food or beverage items on a menu for a restaurant. Customer Table 420 may contain data pertaining to a restaurant's customers. For example, in one embodiment, a customer's location or distance from a restaurant may be recorded. Transaction Table 430 may contain data related to transactions occurring at a restaurant using Payment System 100. For example, Transaction Table 430 may contain customer payment data pertaining to a customer's method of payment. A person having ordinary skill in the art will recognize that a variety of entity attributes and relationships between entities may be configured for Payment System.

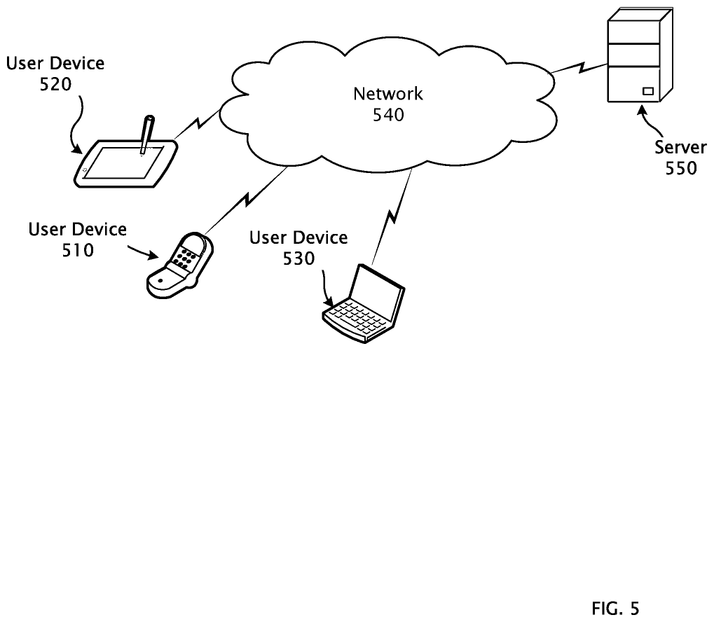

FIG. 5 is a block diagram illustrating an example of a system capable of supporting Payment System, according to one embodiment. Network 540 may include Wi-Fi, cellular data access methods, such as 3 G or 4 G LTE, 5 G, Bluetooth, Near Field Communication (NFC), the internet, local area networks, wide area networks, or any combination of these or other means of providing data transfer capabilities. In one embodiment, Network 540 may comprise Ethernet connectivity. In another embodiment, Network 540 may comprise fiber optic connections.

User Device 510, 520, or 530 may be a smartphone, tablet, laptop computer, smartwatch, intelligent eyewear, or other devices, and may have location-based services, for example, GPS, cell phone tower triangulation capability, or accelerometers, and may have network capabilities to communicate with Server 550. Server 550 may include one or more computers and may serve a number of roles. Server 550 may be conventionally constructed, or may be of a special purpose design for processing data obtained from Payment System 100. A restaurant using Payment System 100 may use a server owned or managed by a service provider. One skilled in the art will recognize that Server 550 may be of many different designs and may have different capabilities. Server 550 may include one more computers and may be of a special purpose design for processing data obtained from Payment System 100.

User Device 510, 520, or 530 may include a device application to support Payment System, for example, allowing a user to request an action, such as order food, or input payment information, such as credit card information. In another embodiment, Device 510, 520, or 530 may display a website hosted on Server 550 in a browser, which may allow a user to request an action or input information. Server 550 may be operated by a party offering Payment System. Server 550 may allow a worker to receive a notification of the requested action.

A restaurant may also provide a User Device 510, 520, or 530 to a customer to provide access to Payment System 100.

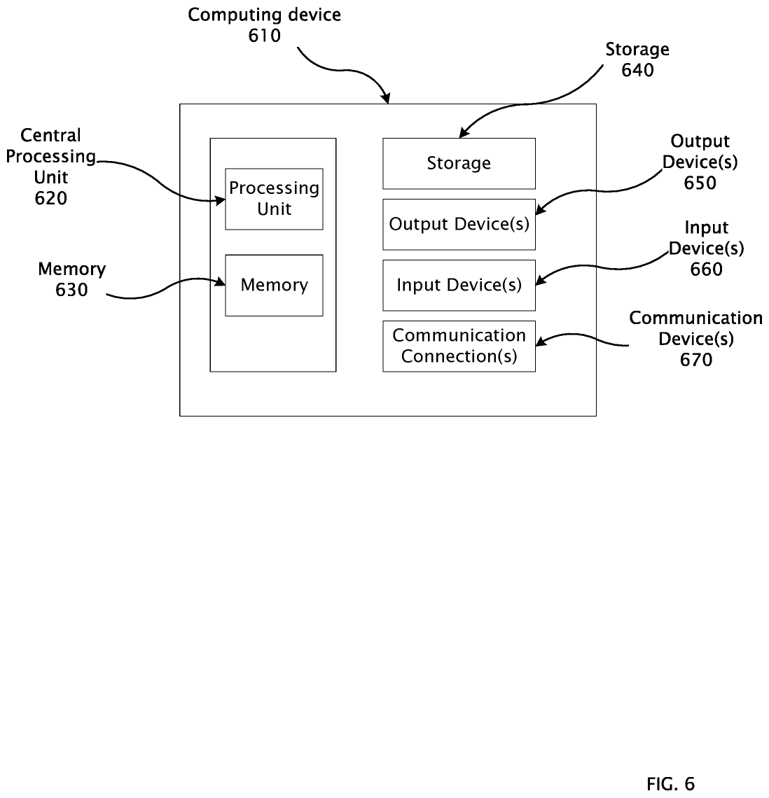

FIG. 6 is a component diagram of a computing device to which Payment System 100 may be applied, according to one embodiment. The Computing Device 610 can be utilized to implement one or more computing devices, computer processes, or software modules described herein, including, for example, a mobile device. In one example, the Computing Device 610 can be used to process calculations, execute instructions, and receive and transmit digital signals. In another example, the Computing Device 610 can be utilized to process calculations, execute instructions, receive and transmit digital signals, receive and transmit search queries and hypertext, and compile computer code suitable for a mobile device. The Computing Device 610 can be any general or special purpose computer now known or to become known capable of performing the steps and/or performing the functions described herein, either in software, hardware, firmware, or a combination thereof.

In its most basic configuration, Computing Device 610 typically includes at least one Central Processing Unit (CPU) 620 and Memory 630. Depending on the exact configuration and type of Computing Device 610, Memory 630 may be volatile (such as RAM), non-volatile (such as ROM, flash memory, etc.) or some combination of the two. Additionally, Computing Device 610 may also have additional features/functionality. For example, Computing Device 610 may include multiple CPUs. The described methods may be executed in any manner by any processing unit in Computing Device 610. For example, the described process may be executed by multiple CPUs in parallel.

Computing Device 610 may also include additional storage (removable and/or non-removable) including, for example, magnetic or optical disks or tap. Such additional storage is illustrated in FIG. 6 by Storage 640. Computer-readable storage media includes volatile and nonvolatile, removable and non-removable media implemented in any method of technology for storage of information such as computer-readable instructions, data structures, program modules, or other data. Memory 630 and Storage 640 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing Device 610. Any such computer-readable storage media may be part of Computing Device 610. But computer-readable storage media may be part of Computing Device 610. But computer-readable storage media does not include transient signals.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

Computing Device 610 may also contain Communication Device(s) 670 that allow the device to communicate with other devices. Communications Device(s) 670 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. Communication media may include wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Computing Device 610 may also have Input Device(s) 660 such as a keyboard, a mouse, a pen, a voice input device, a touch input device, etc. Output device(s) 650 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

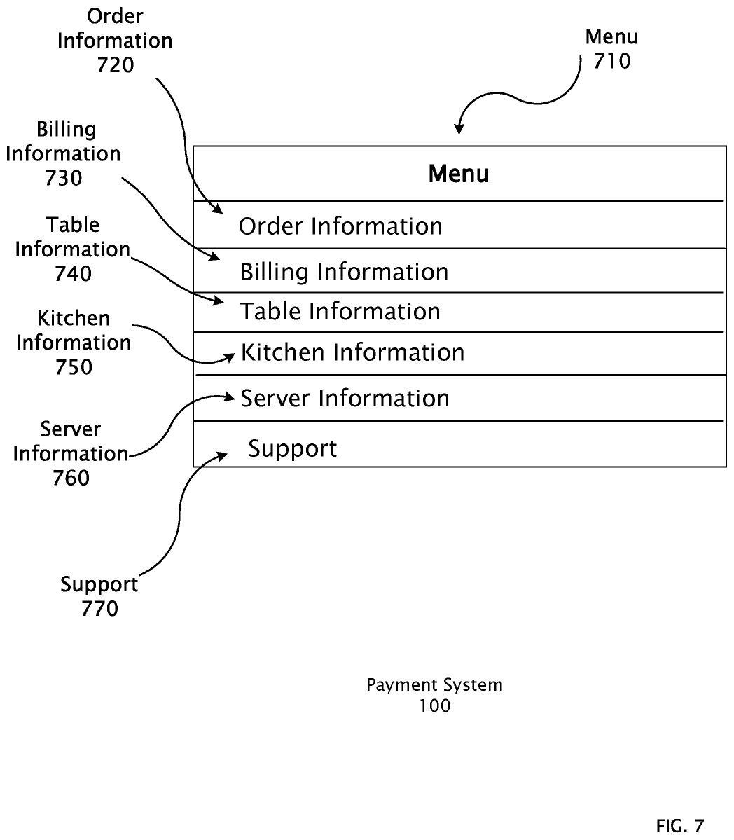

FIG. 7 illustrates a user interface for a device application using Payment System 100, according to another embodiment. In this example, Menu 710 may display a drop-down menu of action items which a restaurant employee acting in a managerial or supervisory capacity may select on a device. For example, a manager or supervisor may select Order Information 720 to view information on orders customers have placed. Such information may include the status of orders and where orders are being sent. Billing Information 730 may provide managers or supervisors with customer payment information. In one embodiment, managers or supervisors may be able to view whether customers have provided payment information and the status of any transactions. Under Billing Information 730, managers or supervisors may also be able to see any method of payment customers are using, including credit card, debit card, cryptocurrency, or any other authorized means for paying. Payment methods may be encrypted and may be secured so that a manager or supervisor may only be able to see the last four digits of a credit card or a debit card. A manager or supervisor may also be able to view information or select options related to payment processing under Billing Information 730. Table Information 740 may provide managers or supervisors with information regarding tables. For example, managers or supervisors may be able to track and control service requests to different tables. Kitchen Information 750 may provide managers or supervisors with the ability to view information on the status of orders as they are being made in the kitchen. Kitchen Information 750 may also provide a function allowing managers or supervisors to communicate with kitchen staff about any issues related to orders. Server Information 760 may provide managers or supervisors with the ability to see the status of servers and see where servers may presently be deployed. Accordingly, Server Information 760 may also allow managers or supervisors to reallocate server resources. Support 770 may enable managers or servers to communicate with a technical consultant to troubleshoot any issues with using Payment System 100.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A system for allowing a customer to order and pay on a user device for goods or services from a provider, comprising:
a processor;
a memory, operably coupled to the processor;
instructions disposed in the memory which, when executed, perform a method comprising:
receiving an order for food or beverages from the user device;
receiving a notification that the received order has been accepted by the provider
receiving a notification that the received order has been prepared by the provider; and
receiving payment information from the user device.

2. The system of claim 1, wherein the user device is a smart phone.

3. A method, comprising:
receiving an order for food or beverages from a user device;
receiving a notification that the received order has been accepted by the provider;
receiving a notification that the received order has been prepared by the provider; and
receiving payment information from the user device.
